(19) United States
(12) Patent Application Publication
(10) Pub. No.: US 2018/0283046 A1
(43) Pub. Date: Oct. 4, 2018

(54) KEY MANAGEMENT PROGRAM AND KEY MANAGEMENT DEVICE

(71) Applicants: Kabushiki Kaisha Toshiba, Minato-ku (JP); Toshiba Infrastructure Systems & Solutions Corporation, Kawasaki-shi (JP)

(72) Inventors: Hiroyasu UCHIDA, Machida (JP); Makoto Kamoi, Toda (JP); Mayuko Shidata, Kawasaki (JP); Shingo Tsurumi, Yokohama (JP)

(73) Assignees: Kabushiki Kaisha Toshiba, Minato-ku (JP); Toshiba Infrastructure Systems & Solutions Corporation, Kawasaki-shi (JP)

(21) Appl. No.: 15/995,941

(22) Filed: Jun. 1, 2018

Related U.S. Application Data
(63) Continuation of application No. PCT/JP2016/085581, filed on Nov. 30, 2016.

(30) Foreign Application Priority Data
Dec. 3, 2015 (JP) 2015-236751
Jul. 22, 2016 (JP) 2016-144260

(51) Int. Cl. E05B 11/00; E05B 17/22; E05B 19/00

(52) U.S. Cl. CPC E05B 11/00; E05B 19/00; E05B 17/22

(57) ABSTRACT

A key management program causes the computer to operate as a position information acquisition unit, a key use condition acquisition unit, and a lock releasing processor. The key use condition acquisition unit acquires key use conditions including a lock releasing time and identification information, and key use location. The lock releasing processor transmits lock releasing signal to release locked state to key management device, if current time is within a range of lock releasing time and identification information included in key use conditions also matches identification information of communicating key management device, and position information acquired is a location preset as key use location.

### CROSS-REFERENCE TO RELATED APPLICATIONS

This is a continuation Application of PCT Application No. PCT/JP2016/085581, filed Nov. 30, 2016, which was published under PCT Article 21(2) in Japanese.

This application is based upon and claims the benefit of priority from Japanese Patent Application No. 2016-144260, filed Jul. 22, 2016, the entire contents of which are incorporated herein by reference.

This application is based upon and claims the benefit of priority from Japanese Patent Application No. 2015-236751, filed Dec. 3, 2015, the entire contents of which are incorporated herein by reference.

### FIELD

Embodiments described herein relate generally to a key management program and a key management device.

### BACKGROUND

To manage a user's entrance to/exit from a specific location, an access management system using an IC card, etc. is generally in actual use. The access control system reads out information from an IC card held over a reader/writer provided near a door, and performs authentication. If the authorization is successful, the system releases a door lock. Such an access control system can record the times when the door is released based on an authentication history. In addition, by setting a time to an authentication condition, the access control system can prevent the door from being released except for the time set as the condition.

There is a demand to set a use condition of a key and leave a history of use, like the aforementioned access control system, also in a combination of a conventional lock (e.g., a key cylinder) and a key.

### BRIEF DESCRIPTION OF THE DRAWINGS

FIG. 1 is a drawing to explain an example configuration of a key management system according to an embodiment.

FIG. 2 is a drawing to explain an example configuration of a key management device according to an embodiment.

FIG. 3 is a drawing to explain an example configuration of a first portable terminal according to an embodiment.

FIG. 4 is a drawing to explain an example configuration of a server according to an embodiment.

FIG. 5 is a drawing to explain an example of a management table according to an embodiment.

FIG. 6 is a sequence drawing to explain an operation of each configuration of a key management system according to an embodiment.

### DETAILED DESCRIPTION

A key management program according to an embodiment is a key management program that is executed by a computer, and causes the computer to operate as a communication unit, a time acquisition unit, a position information acquisition unit, a key use condition acquisition unit, and a lock releasing processor. The communication unit communicates with the key management device that accommodates a key in a locked state in which pulling out of the key is restricted. The time acquisition unit acquires a current time. The position information acquisition unit that acquires position information of the computer. The key use condition acquisition unit acquires key use conditions including a lock releasing time and identification information, and a key use location. The lock releasing processor transmits a lock releasing signal to release the locked state to the key management device, if the current time is within a range of the lock releasing time and the identification information included in the key use conditions also matches identification information of the communicating key management device, and the position information acquired by the position information acquisition unit is a location preset as the key use location.

Hereinafter, embodiments will be described with reference to the drawings.

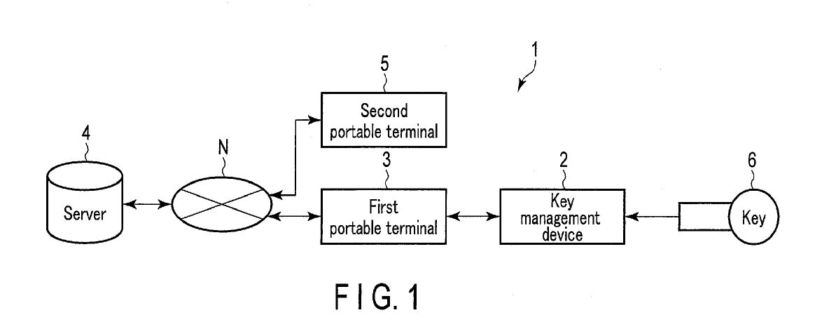

FIG. 1 is an explanatory drawing to explain about a key management system 1 according to an embodiment.

The key management system 1 is a system that manages use of a key 6 corresponding to a lock (e.g., a key cylinder). The key management system 1, for example, allows the key 6 to be used if a preset condition is met. In addition, the key management system 1 can leave a history of use of the key 6.

The key management system 1 comprises, for example, a key management device 2, a first portable terminal 3, a server 4, and a second portable terminal 5. The key management device 2 is configured to communicate with the first portable terminal 3. The first portable terminal 3 and the second portable terminal 5 are configured to communicate with the server 4 via a network N.

The key management device 2 accommodates the key 6 in a locked state where the key 6 cannot be pulled out. The first portable terminal 3 determines whether the condition of use (a key use condition) of the key 6 is met or not, and if the key use condition is met, performs lock releasing processing to transmit a signal (a lock releasing signal) for releasing the locked state to the key management device 2. The server 4 performs setting of the key use condition of the first portable terminal 3 and recoding of a history of use of the key 6. The second portable terminal 5 can browse the use history of the key 6 by accessing the server 4.

For example, a user who entrusts the key 6 of his/her own house to others (e.g., a housekeeping service agent) carries the second portable terminal 5, and the above service agent visiting the house carries the key management device 2 in which the key 6 is accommodated and the first portable terminal 3. Thereby, the service agent performs lock releasing processing to release a locked state of the key management device 2 by the first portable terminal 3 when the service agent visits the user's house. The service agent can take the key 6 of the user's house from the key management device 2 if the lock releasing processing is properly performed by the first portable terminal 3. The user can browse the use history of the key 6 by the second portable terminal 5.

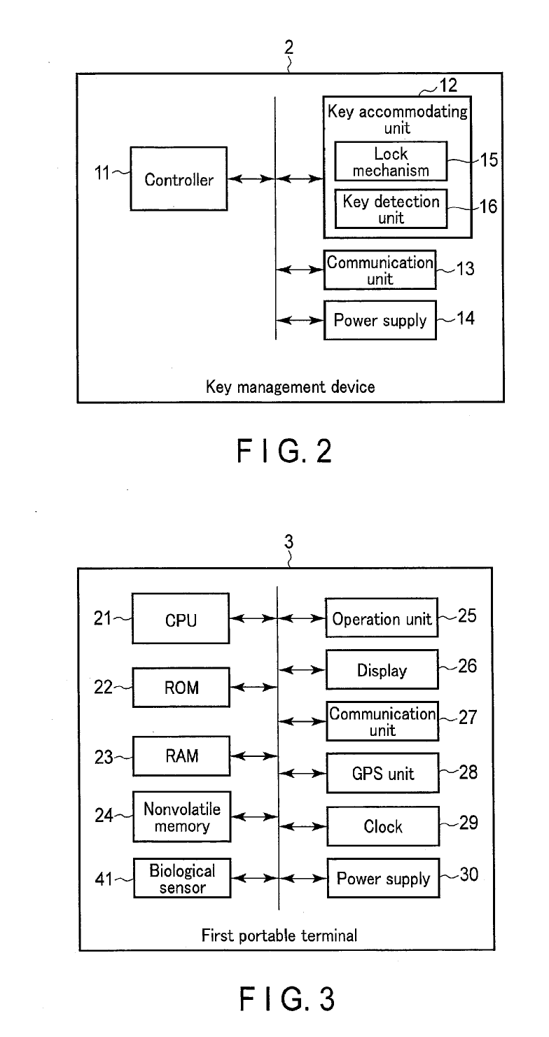

FIG. 2 is an explanatory drawing to explain an example configuration of the key management device 2 according to an embodiment. The key management device 2 comprises a controller 11, a key accommodating unit 12, a communication unit 13, and a power supply 14.

The controller 11 performs control of the key management device 2. The controller 11 is formed of a CPU, a ROM, a RAM, etc. In addition, the controller 11 may be configured by a microcomputer, etc.

The key accommodating unit 12 accommodates the key 6 in a locked state in which the key 6 cannot be pulled out. The key accommodating unit 12 is, for example, configured as a key hole having a similar structure to that of a key cylinder corresponding to the key 6. The key accommodating unit 12 comprises a lock mechanism 15 and a key detection unit 16.

The lock mechanism 15 controls insertion and removal of the key 6 that is inserted into the key hole. The lock mechanism 15 puts the key 6 that is inserted into the key hole of the key accommodating unit 12 into a state (a locked state) in which the key 6 cannot be pulled out from the key hole based on the control of the controller 11. The lock mechanism 15 puts the key 6 that is inserted into the key hole of the key accommodating unit 12 into a state (an unlocked state) in which the key 6 can be pulled out from the key hole based on the control of the controller 11. For example, the lock mechanism 15 comprises an engagement member configured to engage with a part of the key 6 that is inserted into the key hole. The lock mechanism 15 switches between the locked state in which the key 6 is engaged with the engagement member and the unlocked state in which the key 6 is not engaged with the engagement member by driving the engagement member based on the control of the controller 11.

The key detection unit 16 detects whether it is in a state in which the key 6 is inserted into the key hole or in a state in which the key 6 is pulled out from the key hole. For example, if the key accommodating unit 12 is configured as a key cylinder comprising a plurality of pin tumblers, the key detection unit 16 detects whether it is in a state in which the key 6 is inserted into the key hole, or in a state in which the key 6 is pulled out from the key hole, based on the position of the pin tumblers. In addition, the key detection unit 16 may be simply configured to detect the presence/absence of the key 6 with an optical sensor provided near an opening portion of the key hole.

The communication unit 13 performs wireless communications with the first portable terminal 3. The communication unit 13 performs communications with the first portable terminal 3 by, for example, Bluetooth (registered trademark), an NFC (Near Field Communication), a wireless LAN, or some other means.

The power supply 14 feeds electric power to each unit of the key management device 2. The power supply 14 comprises a rechargeable battery. The power supply 14 charges the battery with electric power by a power feeding means that is connected to an external power supply source.

The controller 11 of the key management device 2 establishes a communication path with the first portable terminal 3 by the communication unit 13. In response to polling from the first portable terminal 3, the controller 11 transmits information indicating a state of the controller 11 itself to the first portable terminal 3. For example, the controller 11 has a memory that stores identification information (a key management device ID) of the controller 11 itself. In response to the polling from the first portable terminal 3, the controller 11 transmits the key management device ID to the first portable terminal 3.

In addition, if a lock releasing signal is received from the first portable terminal 3, the controller 11 switches a state of the lock mechanism 15. For example, if the lock releasing signal is received from the first portable terminal 3, the controller 11 switches from a locked state of the lock mechanism 15 to an unlocked state.

If it is detected by the key detection unit 16 that the key 6 is pulled out from the key hole, the controller 11 transmits to the first portable terminal 3 a pull-out notification to indicate that the key 6 is pulled out.

If it is detected by the key detection unit 16 that the key 6 is inserted into the key hole, the controller 11 switches the unlocked state of the lock mechanism 15 to the locked state.

FIG. 3 is an explanatory drawing to explain an example configuration of the first portable terminal 3 according to an embodiment. Note that since the configuration of the second portable terminal 5 is the same as that of the first portable terminal 3, illustrations and detailed explanation about the configuration will be omitted.

The first portable terminal 3 comprises a CPU 21, a ROM 22, a RAM 23, a nonvolatile memory 24, an operation unit 25, a display 26, a communication unit 27, a GPS unit 28, a clock 29, a power supply 30, and a biological sensor 41. The CPU 21, the ROM 22, the RAM 23, the nonvolatile memory 24, the operation unit 25, the display 26, the communication unit 27, the GPS unit 28, the clock 29, and the biological sensor 41 are mutually connected via buses.

The CPU 21 is an operation element that performs arithmetic processing. The CPU 21 performs various processing based on a program stored in the ROM 22 or the nonvolatile memory 24 and data used by the program. The CPU 21 functions as a controller that can execute various operations by executing the program stored in the ROM 22 or the nonvolatile memory 24.

The ROM 22 is a read only nonvolatile memory. The ROM 22 stores a program and data used by the program, etc. The ROM 22 is integrated into the first portable terminal 3, in a state in which a program according to the specification of the first portable terminal 3 and data used by the program are stored in the ROM 22 in advance.

The RAM 23 is a volatile memory that functions as a working memory. The RAM 23 temporarily stores data etc. that is being processed by the CPU 21. In addition, the RAM 23 temporarily stores a program to be executed by the CPU 21.

The nonvolatile memory 24 is a storage medium that can store various information. The nonvolatile memory 24 stores a program and data used by the program, etc. The nonvolatile memory 24 is, for example, a solid state drive (SSD), a hard disk drive (HDD), or an other storage device. Instead of comprising a storage medium, the nonvolatile memory 24 may be configured as a memory I/F, such as a card slot in which a storage medium such as a memory card can be inserted.

The operation unit 25 generates an operation signal based on an operation of an operation member. The operation member is, for example, a touch sensor, and various kinds of buttons. The touch sensor is, for example, a resistant film type touch sensor or an electrical capacitance type touch sensor. That is, the touch sensor acquires information indicating a position designated within a given area. The touch sensor is formed integrally with the display 26 as a touch screen, and inputs a signal indicating a position touched on the display 26 to the CPU 21.

The display 26 displays a screen based on control of the CPU 21. The display 26 comprises a display panel and a driving circuit that causes the display panel to display a screen. The display panel is, for example, a crystal display, an organic EL display, or a display device for displaying an other screen.

The communication unit 27 is a circuit for communicating with the other electronic devices. The communication unit 27 is, for example, connected to the network N via a portable telephone communication network. Thereby, the communication unit 27 can communicate with the server 4 via the network N.

In addition, the communication unit 27 performs, for example, wireless communications with the key management device 2. The communication unit 27 performs communications with the first portable terminal 3 by, for example, Bluetooth, an NFC (Near Field Communication), a wireless LAN, or an other means.

The GPS unit 28 recognizes a position relationship between a GPS satellite and the GPS unit 28 itself based on radio waves output from the GPS satellite. For example, the GPS unit 28 generates positional information indicating a position on the earth of the first portable terminal 3 on which the GPS unit 28 is mounted based on radio waves output from a plurality (at least three or more) of GPS satellites. The GPS unit 28 provides the position information to the CPU 21.

The clock 29 acquires the time. For example, the clock 29 may be configured to acquire a current time by timing an elapsed time from a preset time, or may be configured to acquire a current time from the other devices on the network N.

The power supply 30 feeds electric power to each unit of the first portable terminal 3. The power supply 30 is provided with a rechargeable battery. The power supply 30 charges the battery with electric power by a power feeding means that is connected to an external power supply source.

The biological sensor 41 reads out biological information from the user of the first portable terminal 3. For example, the biological sensor 41 acquires biological information relating to fingerprints of the user of the first portable terminal 3. Specifically, the biological sensor 41 acquires an image of the fingerprints of the user of the first portable terminal 3, and acquires fingerprint data as biological information from the acquired fingerprint images. Note that the biological sensor 41 may be configured to acquire biological information relating to a face, a vein, or an iris, etc. of the user of the first portable terminal 3.

For example, the nonvolatile memory 24 stores a key management program. The key management program is a program that can send a lock releasing signal to the key management device 2 according to a key use condition to be received from the server 4. The CPU 21 performs various processing between the key management device 2 and the server 4 by executing the key management program.

For example, the CPU 21 establishes a communication path with the key management device 2 by the communication unit 27. The CPU 21 reads out a state of the key management device 2 by performing polling with respect to the key management device 2. For example, the CPU 21 reads out a key management device ID of the key management device 2 by performing the polling with respect to the key management device 2.

In addition, the CPU 21 acquires a key use condition from the server 4 by connecting to the server 4 by the communication unit 27. The CPU 21 stores the key use condition acquired from the server 4 in, for example, the nonvolatile memory 24. The CPU 21 may be configured to update the key use condition that is already stored in the nonvolatile memory 24 according to the key use condition acquired from the server 4. In this case, the CPU 21 operates as a lock releasing processor.

The CPU 21 performs lock releasing processing to determine whether to transmit a lock releasing signal to the key management device 2 or not based on the key use condition stored in the nonvolatile memory 24. In this case, the CPU 21 operates as a lock releasing processor.

The key use condition includes, for example, a key management device ID and a lock releasing time. The CPU 21 determines whether or not the key management device ID of the key management device 2 with the established communication path matches a key management device ID indicated by the key use condition. The CPU 21 determines whether or not the current time is within a range of the lock releasing time indicated by the key use condition. For example, if it is determined that the key management device ID of the key management device 2 with the established communication path matches the key management device ID indicated by the key use condition, and also that the current time is within a range of the lock releasing time indicated by the key use condition, the CPU 21 determines to transmit a lock releasing signal with respect to the key management device 2.

Furthermore, the key use condition may include, for example, whether personal authentication is needed or not (personal authentication necessity). The CPU 21 refers to the key use condition, and determines whether the personal authentication is needed or not. The CPU 21 may be configured to perform the personal authentication if it determined that the personal authentication is needed. Furthermore, the CPU 21 may be configured to determine whether or not to transmit a lock releasing signal to the key management device 2, based on the key management ID, the lock releasing time, and a result of the personal authentication (a personal authentication result). Namely, the CPU 21 may be configured to transmit a lock releasing signal to the key management device 2, if the key management device ID of the key management device 2 with the established communication path matches the key management device ID indicated by the key use condition; the current time is within the lock releasing time indicated by the key use condition; and a personal authentication result indicating that the user who is operating the first portable terminal 3 is a regular user.

The personal authentication is processing in which the first portable terminal 3 determines whether the user of the first portable terminal 3 is the regular user or not. The CPU 21 of the first portable terminal 3 stores authentication information (first authentication information) to be used for the personal authentication in a memory, such as the nonvolatile memory 24, in advance. The CPU 21 acquires authentication information (second authentication information) to be used for verification with the first authentication information in the personal authentication. The CPU 21 verifies the first authentication information and the second authentication information, and acquires a personal authentication result. The personal authentication result indicates whether the user who is operating the first portable terminal 3 is the regular user of the first portable terminal 3 or not. The authentication information used for the personal authentication is, for example, a personal identification number (PIN) or biological information. The biological information is, for example, information relating to a living body, such as fingerprints, a face, a vein, or an iris, etc.

For example, if the first portable terminal 3 is configured to use a PIN as the authentication information, the CPU 21 acquires a PIN as the second authentication information according to an input of the operation unit 25. The CPU 21 verifies the acquired PIN as the second authentication information and a PIN as the first authentication information that is stored in advance, and acquires a verification result. Specifically, the CPU 21 determines whether the acquired PIN as the second authentication information matches the PIN as the first authentication information that is stored in advance, or not. If it is determined that the PIN as the second authentication information matches the PIN as the first authentication information, the CPU 21 determines that the user who is operating the first portable terminal 3 is the regular user of the first portable terminal 3. If it is determined that the PIN as the second authentication information does not match the PIN as the first authentication information, the CPU 21 determines that the user who is operating the first portable terminal 3 is not the regular user of the first portable terminal 3.

For example, if the first portable terminal 3 is configured to use biological information as the authentication information, the CPU 21 acquires the biological information as the second authentication information by the biological sensor 41. The CPU 21 calculates a score (e.g., a similarity level) based on the acquired biological information as the second authentication information and biological information as the first authentication information that is stored in advance. The CPU 21 determines whether the calculated score is a preset threshold value or more, or not. If it is determined that the calculated score is the preset threshold value or more, the CPU 21 determines that the user who is operating the first portable terminal 3 is the regular user of the first portable terminal 3. If it is determined that the calculated score is less than the preset threshold value, the CPU 21 determines that the user who is operating the first portable terminal 3 is not the regular user of the first portable terminal 3.

If it is determined to transmit a lock releasing signal based on the key use condition, the CPU 21 transmits the lock releasing signal to the key management device 2. Note that the CPU 21 may be configured to determine whether or not to transmit the lock releasing signal to the key management device 2 based on any one or more of the determination on whether or not the key management device ID of the key management device 2 with the established communication path matches the key management device ID indicated by the key use condition, the determination on whether or not the current time is within a range of the lock releasing time indicated by the key use condition, and the personal authentication result.

If the key is pulled out from the key hole in the key management device 2, the CPU 21 receives a pull-out notification from the key management device 2. If the pull-out notification is received, the CPU 21 notifies the server 4 that the key 6 is used. The CPU 21 notifies the server 4 of the time at which the pull-out notification is received. The CPU 21 acquires position information generated by the GPS unit 28 when receiving the pull-out notification. The CPU 21 treats the acquired position information as position information of the key management device 2. The CPU 21 notifies the server 4 of the acquired position information. For example, if the pull-out notification is received from the key management device 2, the CPU 21 notifies the server 4 that the key 6 is used, and of the time, position information, and a key management device ID as a processing result. The CPU 21 may record the processing result in the nonvolatile memory 24 as a history. In this case, the CPU 21 operates as a position information acquisition unit, a notification unit, and a history recording unit.

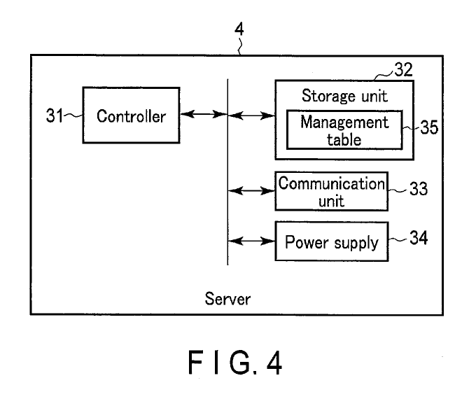

FIG. 4 is an explanatory drawing to explain an exemplary configuration of a server 4 according to an embodiment. The server 4 comprises a controller 31, a storage unit 32, a communication unit 33, and a power supply 34. The server 4 may be configured to further comprise an operation unit that generates an operation signal according to an operation input, and a display that displays a screen.

The controller 31 performs control of the server 4. The controller 31 is formed of a CPU, a ROM, a RAM, etc.

The storage unit 32 has a storage medium that can store various information. The storage unit 32 is configured by, for example, a solid state drive (SSD), a hard disk drive (HDD), or an other storage device. The storage unit 32 has a storage area for storing a management table 35 in the storage medium.

The communication unit 33 is a circuit for communicating with the other electronic devices. The communication unit 33 is, for example, connected to the network N. Thereby, the communication unit 33 performs communications with the other electronic devices via the network N.

The power supply 34 feeds electric power to each unit of the server 4. The power supply 34 receives electric power by a power feeding means connected to an external power supply source, and applies a predetermined voltage to each unit in the server 4 by the received electric power.

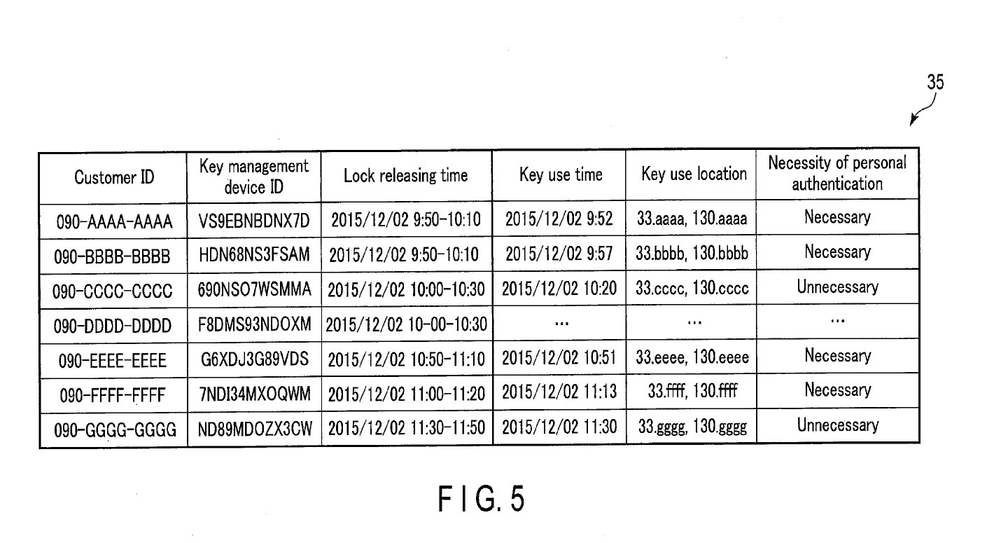

FIG. 5 is an explanatory drawing to explain an example of a management table 35 according to an embodiment. The management table 35 includes various information for setting a key use condition, a use history of the key 6, etc. For example, the management table 35 includes a customer ID, a key management device ID, a lock releasing time, a necessity of personal authentication, a key use time, and a key use location. The customer ID, the key management device ID, the lock releasing time, the key use time, and the key use location are corresponded to one another.

The customer ID is identification information for identifying the second portable terminal 5 carried by the user who entrusts the key 6. The customer ID may be, for example, an email address or a telephone number of the second portable terminal 5, or may be any identification information that is included in the second portable terminal 5 and is notified to the server 4 from the second portable terminal 5 when the second portable terminal 5 is connected to the server 4.

The key management device ID is identification information for identifying the key management device 2. For example, the key management device ID may be a MAC address of the key management device 2 or an ID of a SIM card mounted to the key management device 2, or may be any identification information that is included in the key management device 2 and is notified to the first portable terminal 3 from the key management device 2 when the key management device 2 is connected to the first portable terminal 3.

The lock releasing time is information indicating the times at which the key 6 can be pulled out from the key management device 2. The lock releasing time may include a start time and a finish time.

The necessity of personal authentication is information indicating whether or not to perform personal authentication. If the necessity of personal authentication is “necessary,” the CPU 21 of the first portable terminal 3 adopts a personal authentication result for determination on whether or not to transmit a lock releasing signal to the key management device 2. If the necessity of personal authentication is “unnecessary,” the CPU 21 of the first portable terminal 3 does not adopt the personal authentication result for the determination on whether or not to transmit a lock releasing signal to the key management device 2

The key use time is information indicating the times at which the key 6 is used. The key use time, for example, indicates the time at which the key 6 is pulled out from the key management device 2.

The key use location is information indicating a location where the key 6 is used. The key use location is, for example, position information generated by the first portable terminal 3 when the key 6 is pulled out from the key management device 2.

The controller 31 of the server 4 acquires the customer ID, the key management device ID, the lock releasing time, the necessity of personal authentication, etc. based on information input from an external electronic device, or an operation input by an operation unit (not shown), and writes them into the management table 35.

The controller 31 acquires a key use time, a key use location, etc. from the processing result received from the first portable terminal 3 that is communicating with the key management device 2, and writes them into the management table 35. For example, if a processing result indicating that the key 6 is used is received from the first portable terminal 3, the controller 31 additionally writes the key use time and the key use location corresponding to the key management device ID included in the processing result on the management table 35. For example, if a processing result, indicating that the key 6 is used, is received from the first portable terminal 3, the controller 31 acquires the time included in the processing result as a key use time. For example, if a processing result indicating that the key 6 is used is received from the first portable terminal 3, the controller 31 acquires position information included in the processing result as a key use location.

The controller 31 generates a key use condition based on data on the management table 35. For example, the controller 31 extracts the key management device ID lock releasing time and the necessity of personal authentication from the management table 35, and generates a key use condition. The controller 31 transmits the key use condition to the first portable terminal 3. The controller 31 transmits the key use condition to the first portable terminal 3 in which the communication path is established with the key management device 2 corresponding to the extracted key management device ID. Note that information for identifying the first portable terminal 3, such as an email address, a telephone number, or any identification information of the first portable terminal 3, may be corresponded in the management table 35. The controller 31 may be configured to identify the first portable terminal 3 based on the information for identifying the first portable terminal 3 corresponded to the extracted key management device ID, and transmit the key use condition to the identified first portable terminal 3.

The controller 31 generates information (key management information) for displaying the key use condition, the use history of the key 6, etc. on the second portable terminal 5, and transmits the information to the second portable terminal 5. The key management information includes, for example, information, such as a key use condition, a key use time, and a key use location.

For example, if a processing result indicating that the key 6 is used is received from the first portable terminal 3, the controller 31 generates key management information, and transmits the key management information to the second portable terminal 5. For example, if an email address of the second portable terminal 5 is registered on the management table 35, the controller 31 attaches the key management information to an email directed to the email address of the second portable terminal 5, and transmits the key management information to the second portable terminal 5.

In addition, for example, the controller 31 may be configured to transmit the key management information to the second portable terminal 5 according to a request from the second portable terminal 5. For example, if it is requested to display the key management information from the second portable terminal 5, the controller 31 generates a screen for displaying the key management information, and transmits the screen to the second portable terminal 5. Specifically, if it is requested to display the key management information from the second portable terminal 5 on a Web page, the controller 31 generates an HTML file for displaying the key management information, and transmits the HTML file to the second portable terminal 5.

The second portable terminal 5 carried by the user who entrusts the key 6 of their own house can make the user confirm the use state of the key 6 by acquiring the key management information from the server 4 and displaying the key management information. For example, the second portable terminal 5 acquires the key management information by receiving an email to which the key management information is attached from the server 4. The second portable terminal 5 may be configured to acquire the key management information from the server 4 by accessing a predetermined Web page on the server 4. For example, the second portable terminal 5 may be configured to acquire and display an HTML file generated based on the key management information.

In addition, the second portable terminal 5 may transmit a request (a key use condition change request) to change the above key use condition to the server 4. For example, the second portable terminal 5 can change the lock releasing time and the personal authentication necessity, etc. of the management table 35 on the server 4 by transmitting a new lock releasing time as the key use condition change request to the server 4. The server 4 newly generates a key use condition if the lock releasing time of the management table 35 is changed, and transmits the key use condition to the first portable terminal 3. Thereby, the second portable terminal 5 can change the key use condition in the first portable terminal 3. In addition, for example, the second portable terminal 5 may be configured to transmit a request to immediately release the locked state of the key management device 2 to the first portable terminal 3 via the server 4.

For example, the second portable terminal 5 transmits the key use condition change request to the server 4 by email. For example, the second portable terminal 5 may be configured to transmit the key use condition change request to the server 4 by accessing a predetermined Web page on the server 4. Furthermore, the second portable terminal 5 may be configured to directly transmit the key use condition change request to the first portable terminal 3 by email.

The second portable terminal 5 may be configured to execute changing of a key use condition and checking of a use history of the key 6 like the above by a program. In addition, a program stored in the second portable terminal 5 and a key management program stored in the first portable terminal 3 may be composed in common and may be operated with a part of their functions being restricted.

Next, a flow of a series of operations of each structure of a key management system according to an embodiment will be described.

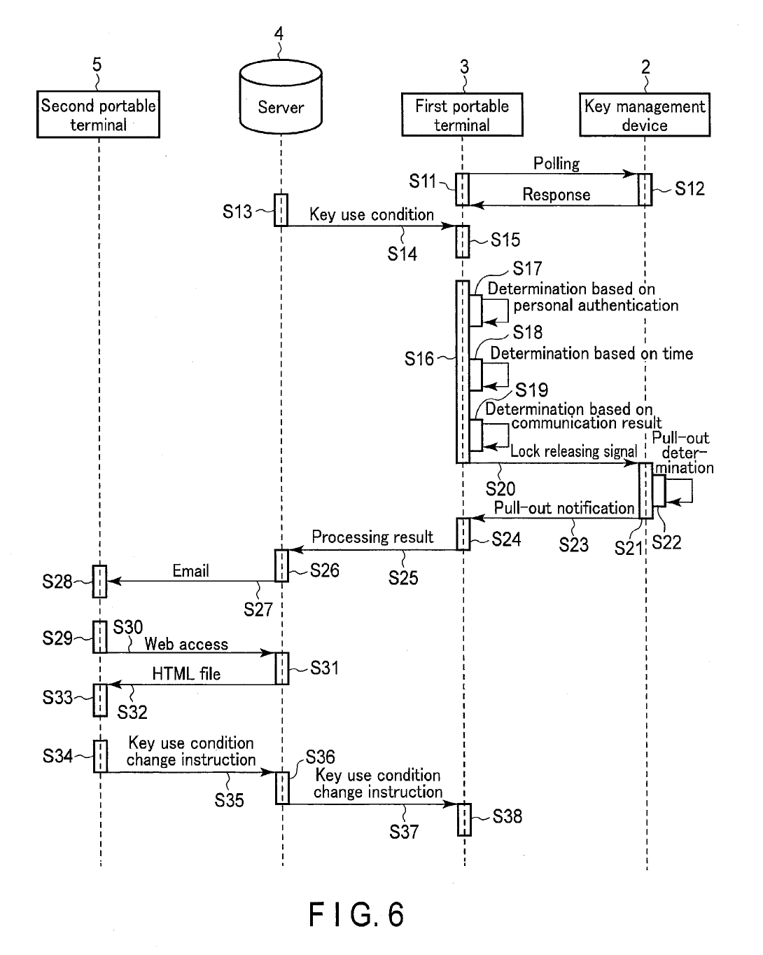

FIG. 6 is a sequence diagram to explain an operation of each structure of a key management system according to an embodiment. Herein, the first portable terminal 3 will be described as a configuration to determine whether or not to transmit a lock releasing signal to the key management device 2 based on a key management device ID, a lock releasing time, and a personal authentication result.

If the communication path is established with the key management device 2, the first portable terminal 3 performs processing to send polling to the key management device 2 at regular time intervals (step S11). If polling is received from the first portable terminal 3, the key management device 2 reads out its own state, key management device ID, etc., and replies a response to which the read-out information is added to the first portable terminal 3 (step S12). The first portable terminal 3 and the key management device 2 perform steps S11 and S12 at regular time intervals, and thereby the first portable terminal 3 successively recognizes the state of the key management device 2.

The server 4 generates a key use condition based on data on the management table 35 at a discretionary timing; in a case in which the management table 35 is updated; or at regular time intervals (step S13). The server 4 transmits the generated key use condition to the first portable terminal 3 (step S14).

The first portable terminal 3 writes the key use condition acquired from the server 4 in the nonvolatile memory 24 (step S15).

The first portable terminal 3 performs lock releasing processing at a discretionary timing; in a case in which the key use condition of the nonvolatile memory 24 is updated; or at regular time intervals (step S16). First of all, the first portable terminal 3 refers to the key use condition, and determines whether the personal authentication is needed or not. If it is determined that the personal authentication is necessary, the first portable terminal 3 performs the personal authentication to determine whether the user who is operating the first portable terminal 3 is the regular user of the first portable terminal 3 or not (step S17).

In addition, the first portable terminal 3 determines whether the current time is within a range of the lock releasing time indicated by the key use condition, or not (step S18). Next, the first portable terminal 3 determines whether or not the key management device ID of the key management device 2 with the established communication path matches the key management device ID indicated by the key use condition (step S19). If it is determined that the key management device ID of the key management device 2 with the established communication path matches the key management device ID indicated by the key use condition; the current time is within a range of the lock releasing time indicated by the key use condition; and the personal authentication result, indicating that the user who is operating the first portable terminal 3 is the regular user of the first portable terminal 3, is obtained, the first portable terminal 3 determines to transmit the lock releasing signal to the key management device 2. If it is determined to transmit the lock releasing signal from the key use condition, the first portable terminal 3 transmits the lock releasing signal to the key management device 2 (step S20).

If the lock releasing signal is received from the first portable terminal 3, the key management device 2 switches the locked state of the lock mechanism 15 to the unlocked state (step S21). Furthermore, the key management device 2 determines whether the key 6 is pulled out from the key hole or not (step S22). If it is determined that the key 6 is pulled out from the key hole, the key management device 2 transmits a pull-out notification to indicate that the key 6 is pulled out to the first portable terminal 3 (step S23).

If the pull-out notification is received from the key management device 2, the first portable terminal 3 records that the key 6 is used, the time, position information, and a key management device ID as a processing result in, for example, the nonvolatile memory 24 (step S24) Furthermore, the first portable terminal 3 notifies the server 4 of the processing result (step S25).

The server 4 acquires a key use time, a key use location, etc. based on the processing result received from the first portable terminal 3, and updates the management table 35 by using the acquired key use time and key use location (step S26). The server 4 generates the key management information based on the information of the management table 35 that is updated in a case in which the processing result is received from the first portable terminal 3, and transmits the generated key management information to the second portable terminal 5 by email (step S27).

The second portable terminal 5 acquires the key management information by receiving the email to which the key management information is attached from the server 4, and displays the acquired key management information (step S28). Thereby, the second portable terminal 5 can permit the user to check the use state of the key 6.

If an operation for accessing a predetermined Web page on the server 4 is performed (step S29), the second portable terminal 5 requests the server 4 for access to the Web page that displays the key management information (step S30). If it is requested to display the key management information from the second portable terminal 5 on the Web page, the server 4 generates an HTML file for displaying the key management information (step S31). The server 4 transmits the generated HTML file to the second portable terminal 5 (step S32). The second portable terminal 5 displays the HTML file transmitted from the server 4 (step S33). Thereby, the second portable terminal 5 can permit the user to check the use state of the key 6.

If an operation for changing the key user condition is performed (step S34), the second portable terminal 5 transmits the key use condition change request for requesting the server 4 to change the key use condition to the server 4 (step S35). If the key use condition change request is received from the second portable terminal 5, the server 4 updates the key use condition by overwriting the management table 35 with a new lock releasing time included in the key use condition change request (step S36). For example, the server 4 recognizes a customer ID on the management table 35 based on a telephone number, an email address, or other identifiers of the second portable terminal 5 that transmitted the key use condition change request. The server 4 updates the information on the management table 35 by overwriting the lock releasing time corresponded to the recognized customer ID with the lock releasing time of the key use condition change request. The server 4 generates the key use condition based on the data on the management table 35 if the management table 35 is updated, and transmits the key use condition to the first portable terminal 3 corresponding to the key management device ID corresponded to the above customer ID (step S37) The first portable terminal 3 updates the key use condition by overwriting the nonvolatile memory 24 with the new key use condition acquired from the server 4 (step S38).

As described above, the key management system 1 comprises the key management device 2 and the first portable terminal 3 having a key management program stored therein. The key management device 2 comprises the key accommodating unit 12 that accommodates the key 6 in a locked state. The first portable terminal 3 determines whether or not to release the locked state of the key management device 2 based on a key use condition acquired in advance. If it is determined to release the locked state of the key management device 2, the first portable terminal 3 releases the locked state of the key management device 2. Thereby, the key management system 1 can set a condition for use of the conventional key 6 corresponding to a key cylinder, etc. As a result, the security of key management can be improved.

For example, the first portable terminal 3 determines whether or not a current time is a preset lock releasing time. The first portable terminal 3 determines whether or not it is connected to the preset key management device 2 based on a key management device ID. The first portable terminal 3 determines whether or not the user who is operating the first portable terminal 3 is the regular user of the first portable terminal 3. The first portable terminal 3 determines whether or not to release the locked state of the key management device 2, based on the determination results of whether or not the current time is the preset lock releasing time, whether or not it is connected to the preset key management device 2, and whether or not the user who is operating the first portable terminal 3 is the regular user of the first portable terminal 3. Thereby, with time, a combination of the first portable terminal 3 and the key management device 2, a result of the personal authentication, etc. as conditions, the key management system 1 can set the conditions for use of the conventional key 6 corresponding to a key cylinder, etc. As a result, the security of key management can be improved.

The key management device 2 detects that the key 6 is pulled out from the key hole of the key accommodating unit 12 by the key detection unit 16, and transmits the detection result to the first portable terminal 3. If the detection result of pulling out of the key 6 is received from the key management device 2, the first portable terminal 3 records time, position information, a key management device ID, etc. as a processing result so as to leave a use history of the key 6. Furthermore, if the detection result of pulling out of the key 6 is received from the key management device 2, the first portable terminal 3 transmits the processing result to the server 4 via the network N so as to leave the use history of the key 6 in the server 4. As a result, the security of key management can be improved.

The first portable terminal 3 updates the key use condition according to information output from the second portable terminal 5. Thereby, the key management system 1 can change the key use condition, and thus the convenience can be improved.

In the above embodiment, it is explained that the first portable terminal 3 determines to transmit the lock releasing signal to the key management device 2, if it is determined that the key management device ID of the key management device 2 with the established communication path matches the key management device ID indicated by the key use condition, and also that the current time is within a range of the lock releasing time indicated by the key user condition, but the configuration is not limited thereto. The first portable terminal 3 may be configured to determine whether to transmit the lock releasing signal to the key management device 2 based on either one of the determination that the key management device ID of the key management device 2 with the established communication path matches the key management device ID indicated by the key use condition and the determination that the current time is within a range of the lock releasing time indicated by the key user condition.

In the above embodiment, it is explained that if the key use condition is transmitted to the first portable terminal 3, the server 4 transmits the key use condition to the first portable terminal 3 in which the communication path is established with the key management device 2 corresponding to the key management device ID extracted from the management table 35, but the configuration is not limited thereto. In the management table 35, information for identifying the first portable terminal 3, such as an email address, a telephone number, or any identification information of the first portable terminal 3 may be corresponded. In this case, the server 4 may be configured to identify the first portable terminal 3 based on information for identifying the first portable terminal 3 corresponded to the key management device ID extracted from the management table 35, and transmit the key use condition to the identified first portable terminal 3.

In the above embodiment, it is explained that if it is determined that the key management device ID of the key management device 2 with the established communication paths matches the key management device ID indicated by the key use condition, and also that the current time is within a range of the lock releasing time indicated by the key use condition, the first portable terminal 3 determines to transmit the lock releasing signal to the key management device 2, but the configuration is not limited thereto. The first portable terminal 3 may be configured to further perform determination based on whether the key 6 is about to be used in a preset location or not.

In this case, position information is added to the key use condition. The first portable terminal 3 acquires its own position information by the GPS unit 28, and determines whether a difference between the acquired position information and the position information indicated by the key use condition is less than a preset value or not. The first portable terminal 3 may be configured to determine whether or not to transmit the lock releasing signal to the key management device 2 based on any one of the determination on whether or not a difference with the position information indicated by the key use condition is less than a preset value, the determination on whether or not the key management device ID of the key management device 2 with the established communication path matches the key management device ID indicated by the key use condition, and the determination on whether or not the current time is within a range of the lock releasing time indicated by the key use condition, or a plurality of logical products. According to such a configuration, the key management system 1 can prevent the key 6 from being pulled out from the key management device 2 in locations other than the location set by the key use condition. Thereby, the creation of a duplicate key can be prevented, and the security can be improved.

In the above-described embodiment, it is explained that the server 4 is configured to comprise the management table 35, but the configuration is not limited thereto. The first portable terminal 3 may be configured to comprise the management table 35. In this case, the first portable terminal 3 performs updates of the management table 35, setting of a key use condition, etc. based on information output from the second portable terminal 5. According to such a configuration, it is not necessary to interpose the server 4, thereby achieving simplification of the system.

In addition, the second portable terminal 5 may be configured to comprise the management table 35. In this case, the second portable terminal 5 performs updates of the management table 35, and setting of a key use condition to the first portable terminal 3 based on operations or information input from the other electronic devices. According to such a configuration as well, it is not necessary to interpose the server 4, thereby achieving simplification of the system.

If it is detected by the key detection unit 16 that the key 6 is pulled out in a state in which the lock mechanism 15 is not in an unlocked state, the key management device 2 transmits a notification to indicate an abnormality to the first portable terminal 3. If the notification to indicate an abnormality is received, the first portable terminal 3 notifies the server 4 to that effect. The server 4 transmits the notification to indicate an abnormality to the second portable terminal 5. In addition, the first portable terminal 3 may transmit the notification to indicate an abnormality to the second portable terminal 5 directly. According to such a configuration, it is possible to detect that the key 6 is forcibly pulled out in a locked state, and to output an alert. As a result, the security can be improved.

The key management device 2 may be configured to notify the first portable terminal 3 of a notification (an insertion notification) to indicate that the key 6 is inserted if it is detected by the key detection unit 16 that the key 6 is inserted into the key hole. In this case, the first portable terminal 3 notifies the server 4 of a notification to indicate an abnormality if the insertion notification is not received within a preset time from the receipt of the pull-out notification. The server 4 transmits the notification to indicate an abnormality to the second portable terminal 5. In addition, the first portable terminal 3 may transmit the notification to indicate an abnormality to the second portable terminal 5 directly. According to such a configuration, it is possible to detect that the key 6 is not returned to the key management device 2, and to output an alert. In addition, it is possible to detect that the key 6 is taken away to an area that is uncommunicable with the first portable terminal 3 while a lock mechanism of the key management device 2 remains unlocked, and to output an alert. As a result, the security can be improved.

The first portable terminal 3 may be configured to perform communications with the server 4 and the second portable terminal 5 by using information of a SIM that the key management device 2 has. According to such a configuration, in a case of transmitting a key use condition from the server 4 to the first portable terminal 3, it is possible to identify the first portable terminal 3 to which to transmit the key use condition based on the information of the SIM of the key management device 2.

In the above-described embodiment, it is explained that the first portable terminal 3 is configured to verify the first authentication information with the second authentication information to acquire a personal authentication result, and use the acquired personal authentication result for determination on whether or not to transmit a lock releasing signal to the key management device 2, but the configuration is not limited thereto. The first portable terminal 3 may be configured to use a result of personal authentication performed in advance for determination on whether or not to transmit a lock releasing signal to the key management device 2. The personal authentication performed in advance is, for example, the personal authentication for releasing an operation lock of the first portable terminal 3. The first portable terminal 3 may be configured to permit activation of a key management program if it is determined that the user of the first portable terminal 3 is the regular user, and to prohibit activation of the key management program if it is determined that the user of the first portable terminal 3 is not the regular user. Furthermore, the first portable terminal 3 may be configured to use a result of personal authentication at the time of activating a key management program for determination on whether or not to transmit a lock releasing signal to the key management device 2.

Note that the functions explained in each of the above-described embodiments are not limited to be configured by using hardware, and can also be realized by causing a computer to read a program in which each function is written by using software. Each function may be configured by selecting software or hardware as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1: A computer-readable non-transitory storage medium storing a key management program executed by a computer, the program causing the computer to operate as:
a communication unit that communicates with a key management device that accommodates a key in a locked state in which pulling out is restricted;
a time acquisition unit that acquires a current time;
a position information acquisition unit that acquires position information of the computer;
a key use condition acquisition unit that acquires a key use condition including a lock releasing time, identification information, and a key use location; and
a lock releasing processor that transmits a lock releasing signal to release the locked state to the key management device, if the current time is within a range of the lock releasing time, the identification information included in the key use condition matches identification information of the communicating key management device, and the position information acquired by the position information acquisition unit is a location preset as the key use location.

2: The computer-readable non-transitory storage medium storing the key management program according to claim 1, further causing the computer to operate as a history recording unit that records history information in which a current time is a key use time, if a lock releasing signal is transmitted to the key management device by the lock releasing processor and a pull-out notification to indicate that the key is pulled out is received from the key management device.

3: The computer-readable non-transitory storage medium storing the key management program according to claim 2, further causing the computer to operate as a position information acquisition unit that acquires position information of the computer if the pull-out notification is received from the key management device,
wherein the history recording unit records the history information including the position information in a memory.

4: The computer-readable non-transitory storage medium storing the key management program according to claim 1, wherein the lock releasing processor restricts releasing of the locked state of the key management device if a difference between the available location included in the key use condition and the position information is a preset value or more,
and permits releasing of the locked state of the key management device if the difference is less than the preset value.

5: The computer-readable non-transitory storage medium storing the key management program according to claim 3, wherein the key use condition further includes a necessity of personal authentication, and
wherein the lock releasing processor performs personal authentication to determine whether or not a user who is operating the computer is a regular user of the computer if the personal authentication is necessary in the key use condition, and permits releasing of the locked state of the key management device if it is determined that the user who is operating the computer is the regular user of the computer.

6: The computer-readable non-transitory storage medium storing the key management program according to claim 2, further causing the computer to operate as a notification unit that notifies an external device of the history information.

7: The computer-readable non-transitory storage medium storing the key management program according to claim 6, wherein the notification unit notifies an external device of a notification to indicate an abnormality if an insertion notification to indicate that the key is inserted is not received from the key management device within a preset time from a receipt of the pull-out notification.

8: A key management device comprising: a key accommodating unit that accommodates a key in a locked state in which pulling out is restricted;
a communication unit that establishes a communication with an external device;
a controller that releases the locked state if a lock releasing signal is received from the external device;
a key detection unit that detects that the key is pulled out from the key accommodating unit; and
a notification unit that notifies the external device that the key is pulled out.

9: The key management device according to claim 8, wherein the notification unit transmits a notification to indicate an abnormality to the external device if it is detected by the key detection unit that the key is pulled out from the key accommodating unit in a state in which the lock releasing signal is not received.

10: A key management system comprising a key management device that accommodates a key in a locked state in which pulling out is restricted and a portable terminal that controls the key management device,
wherein the portable terminal comprises:
a communication unit that communicates with the key management device;
a time acquisition unit that acquires a current time;
a position information acquisition unit that acquires position information of the portable terminal;
a key use condition acquisition unit that acquires a key use condition including a lock releasing time, identification information, and a key use location; and
a lock releasing processor that transmits a lock releasing signal to release the locked state to the key management device, if the current time is within a range of the lock releasing time, the identification information included in the key use condition matches identification information of the communicating key management device and the position information acquired by the position information acquisition unit is a location preset as the key use location, and
wherein the key management device comprises:
a key accommodating unit that accommodates a key in a locked state in which pulling out is restricted;
a communication unit that establishes communication with the portable terminal;
a controller that releases the locked state if a lock releasing signal is received from the portable terminal;
a key detection unit that detects that the key is pulled out from the key accommodating unit; and
a notification unit that notifies the portable terminal that the key is pulled out.
